(19) United States
(12) Patent Application Publication
(10) Pub. No.: US 2026/0209006 A1
(43) Pub. Date: Jul. 23, 2026

(54) DEVICE FOR CARRYING A DRIVE MOTOR OF AN ELEVATOR SYSTEM

(71) Applicant: Inventio AG, Hergiswil (CH)

(72) Inventors: Pradeep Kumbar, Pune Maharashtra (IN); Nilesh Thombare, Pune Maharashtra (IN); Romeo Lo Jacono, Gravesano (CH)

(21) Appl. No.: 19/142,297

(22) PCT Filed: Dec. 18, 2023
(86) PCT No.: PCT/EP2023/086230

§ 371 Date: Jun. 23, 2025

(30) Foreign Application Priority Data
Dec. 31, 2022 (EP) 22217432.8

(51) Int. Cl. B66B 11/00; B66B 7/02; B66B 19/00

(52) U.S. Cl. CPC B66B 11/0045; B66B 7/025; B66B 19/005

(57) ABSTRACT

A device carrying a drive motor of an elevator system includes a carrier with a receptacle fastening the drive motor to the carrier, a bracket, and a support. In the assembled state of the device, the carrier is fastened by one end to a side wall of a shaft of the elevator system, the receptacle is arranged on a portion of the carrier that projects into the shaft, and the bracket is fastened to the same side wall as the carrier and is arranged below the carrier. A support, an elevator car guide rail, supports the portion of the carrier that projects into the shaft on a portion of the bracket that projects into the shaft.

### FIELD

The present invention relates to a device for carrying a drive motor of an elevator system. Furthermore, the invention relates to a method for assembling the device. Furthermore, the invention relates to a system for carrying a plurality of drive motors of an elevator system, and to an elevator system.

### BACKGROUND

An elevator system, as used to transport persons and/or goods in buildings, may comprise a drive motor for raising and/or lowering the car and/or a counterweight connected to the car. Such a drive motor can, for example, be arranged in a shaft head by means of a carrier structure.

EP 2 361 214 B1 describes a carrier structure which is formed by a cross member arranged in the shaft and a longitudinal member for carrying the cross member on a carrying element of the shaft.

U.S. Pat. No. 6,006,865 A describes a carrier structure that can be swung into the shaft for maintenance and repair purposes.

U.S. Pat. No. 6,446,762 B1 describes a carrier structure in the form of a two-part frame that can be fastened to an upper end of the shaft.

US 2004/0084251 A1 describes a carrier structure that can be fastened to an upper end of a guide rail.

### SUMMARY

There may be a need for an alternative device for carrying a drive motor of an elevator system. Furthermore, there may be a need for a system for carrying a plurality of drive motors of an elevator system, for example to allow the use of a plurality of smaller drive motors instead of a single larger drive motor to move the car. Furthermore, there may be a need for a guide rail consisting of a plurality of identical guide rail portions and a carrier supported on the guide rail, which allows the guidance of a car brake attached on the car roof.

These needs can be met by the subject matter of the advantageous embodiments defined in the following description and in the accompanying drawings.

A first aspect of the invention relates to a device for carrying a drive motor of an elevator system which comprises a shaft connecting a plurality of stories of a building to one another and a car that can be moved in the shaft between the stories by means of the drive motor, having a car brake attached to the car, and comprises a carrier with a receptacle for fastening the drive motor to the carrier. A guide element for guiding the car brake is attached to the carrier.

The guide element allows the car brake(s) attached on the car roof to be guided in the last subportion (while the car brake is at the height of the carrier and the car approaches the carrier height). Such a need arises when the carrier is supported on the guide rail and the brake is located on the car roof. The guide element ensures that the car brake is reliably guided in all possible positions in the shaft. The guide element thus substantially represents an extension of the guide rail running along the carrier. This makes it possible to use a guide rail consisting of a plurality of identical rail portions and a carrier supported on the uppermost rail portion, and still to allow the guidance of the car brake arranged on the car roof in all positions. This makes it possible to provide a modular low-head elevator with car brake.

In the assembled state, the device can be arranged at least partially in a shaft head, i.e., in an upper end of the shaft. The height of the shaft head can, for example, correspond to a vertical distance from a ceiling of the shaft to a floor of an uppermost story. However, other installation sites are also possible.

For example, the shaft can be limited by four different side walls, which can be arranged opposite one another in pairs. In other words, the shaft can have a rectangular cross section. When the device is in the assembled state, the carrier can be fastened to one of these four side walls.

The carrier can be fastened to the side wall by screwing, for example. It is also possible that a portion of the carrier is embedded in the side wall, for example by being concreted into it, while another portion of the carrier projects from the side wall.

The receptacle can, for example, be arranged at a free end of the carrier. In this case, the drive motor can be fastened to the carrier via the receptacle in such a way that the drive motor, viewed in the longitudinal direction of the carrier, projects beyond the free end of the carrier in a direction away from the side wall. However, the receptacle can also be arranged at another location of the carrier, for example between the free end and the (fixed) end with which the carrier is fastened to the side wall when the device is in the assembled state.

The carrier can be designed to additionally carry at least one further drive component of the elevator system, for example a drive battery, a brake chopper, an elevator controller, a gear, a drive pulley and/or a deflection pulley.

According to an embodiment, the guide element consists of a sheet metal profile attached to the carrier. The sheet metal profile has a guide portion with a guide surface for guiding the car brake. Furthermore, the sheet metal profile has a fastening portion with a fastening surface, preferably running substantially parallel to the guide surface, for fastening the guide element to the carrier.

According to an embodiment, the guide element further comprises a connecting portion for connecting the guide portion and the fastening portion. The connecting portion preferably runs perpendicularly to the guide portion and/or fastening portion.

According to an embodiment, the guide element is designed as a one-piece and bent sheet metal stamped part.

According to an embodiment, the support can be formed by a longitudinal portion of a guide rail for guiding the car in the longitudinal direction of the shaft. When the device is in the assembled state, the longitudinal portion can be fastened to the carrier on the one hand and to another point in the shaft on the other.

According to an embodiment, the guide rail has a guide surface, wherein the guide portion of the guide element is arranged substantially directly adjacent to the guide rail, so that the guide surface of the guide rail and the guide surface of the guide portion are arranged substantially in one plane and the guide surface of the guide element is thus substantially a direct continuation of the guide surface of the guide rail.

According to an embodiment, the guide rail may be a hollow rail. Such a guide rail is particularly rigid and stable.

According to an embodiment, the longitudinal portion can be an end portion of the guide rail. In other words, the carrier can be arranged at an upper end of the guide rail when the device is in the assembled state. For example, the carrier can rest on the upper end of the guide rail.

Preferably, the guide element is designed such that it can be inserted into the guide rail with the fastening portion and is thus connectible or connected to the guide rail in a form-fitting manner.

According to an embodiment, the device is designed or configured such that, in the assembled state of the device, the carrier is fastened with one of its ends to a side wall of the shaft, and the receptacle is arranged on a portion of the carrier that projects into the shaft.

However, the underside of the carrier can also be connected to the upper end of the support via at least one connecting part, for example in the form of an intermediate plate arranged between the carrier and the support. When the device is in the assembled state, the connecting part can be fastened to the carrier and/or the support, for example screwed and/or welded thereto. The connecting part can also comprise a fastening portion for additionally fastening the drive motor to the connecting part. This allows a statically determined mounting of the drive motor at two mounting points, namely the receptacle on the carrier and the fastening portion.

According to an embodiment, the end of the carrier fastened to the side wall and/or the ceiling can be fastened to the side wall and/or the ceiling via at least one vibration-damping intermediate piece. Such an intermediate piece can, for example, be or comprise a rubber part. This means that unwanted vibrations and/or noises during operation of the drive motor can be noticeably reduced or avoided.

The support may be designed to bear at least part of a weight force of the carrier fastened to the side wall and having the drive motor (and additionally one or more other drive components). When the device is in the assembled state, the support can be connected, for example screwed and/or welded, to the carrier on the one hand and to another point in the shaft on the other.

It is possible that the carrier has a horizontal longitudinal direction in the assembled state of the device and/or the support has a vertical longitudinal direction in the assembled state of the device. A second aspect of the invention relates to a system for carrying a plurality of drive motors of an elevator system which comprises a shaft connecting a plurality of stories of a building to one another and a car that can be moved in the shaft between the stories by means of the drive motors. The system comprises a plurality of devices, each device being the device described above and below, and the carrier of each device having a receptacle for fastening one of the drive motors to the carrier.

In other words, the system may comprise a separate device for each drive motor. The devices can, for example, be assembled independently of one another.

It is possible that the carriers are arranged at the same height in the shaft when the system is in the assembled state.

Such a system allows simple and space-saving installation of a plurality of drive motors in the shaft, for example in the shaft head. Thus, instead of a single larger drive motor, a plurality of smaller drive motors can be used to move the car, which can have a positive effect on the manufacturing costs and/or the maintenance and/or repair costs.

A third aspect of the invention relates to an elevator system which comprises a shaft connecting a plurality of stories of a building to one another, and a car that can be moved in the shaft between the stories.

The elevator system further comprises a drive motor for moving the car, and the device described above and below, wherein the drive motor is fastened to the carrier via the receptacle.

Alternatively, the elevator system further comprises a plurality of drive motors for moving the car, and the system described above and below, wherein each drive motor is fastened to one of the carriers via one of the receptacles.

In addition, the elevator system may comprise a counterweight coupled to the car via support means, which counterweight is lowered when the car is raised and is raised when the car is lowered. In this case, the drive motor or motors can be designed to displace the support means.

A fourth aspect of the invention relates to a method for assembling a device for carrying a drive motor of an elevator system, in particular the device described above and below, wherein the elevator system comprises a shaft connecting a plurality of stories of a building to one another and a car that can be moved in the shaft between the stories by means of the drive motor. The method comprises the following steps: providing a support and a carrier with a receptacle for fastening the drive motor to the carrier; fastening the carrier with one of its ends to the side wall, in particular the same side wall, and/or the ceiling of the shaft, wherein the receptacle is arranged on a portion of the carrier, in particular fastened to the side wall, which portion projects into the shaft.

The above steps can be performed in the order given or in a different order than the order given.

It should be noted that features of the device described above and below may also be features of the method (and vice versa).

Embodiments of the invention may be considered to be based on the concepts and findings described below. These embodiments are not to be understood as limiting the scope of the invention. According to an embodiment, the carriers of different devices can be fastened to the same side wall of the shaft in the assembled state of the system. In other words, all carriers of the system can be fastened to the same side wall of the shaft.

Alternatively, at least one of the carriers may be fastened to a different side wall than the remaining carrier or carriers.

According to an embodiment, in the assembled state of the system, the carriers can be connected to one another at their portions which project into the shaft and via at least one connecting part to form a frame. The connecting part can, for example, be in the form of a plate or a support. Thus, the rigidity of the carriers can be significantly increased with little design effort compared to embodiments in which the carriers are not connected to one another to form a frame.

Embodiments of the invention will be described below with reference to the accompanying drawings. Neither the description nor the drawings are to be understood as limiting the scope of the invention.

### DESCRIPTION OF THE DRAWINGS

FIG. 1 shows a subregion of an elevator system according to an embodiment of the invention.

FIG. 2 is a perspective view of a drive motor of a system, according to an embodiment of the invention, carrying an elevator system.

FIG. 3 is a subportion of the system of FIG. 2.

FIG. 4 is a plan view of a subportion of the system of FIG. 3.

FIG. 5 is a plan view of a system, according to an embodiment of the invention, carrying two drive motors of an elevator system.

The drawings are purely schematic and are not to scale. Where the same reference signs are used in different drawings, these reference signs denote identical or equivalent features.

### DETAILED DESCRIPTION

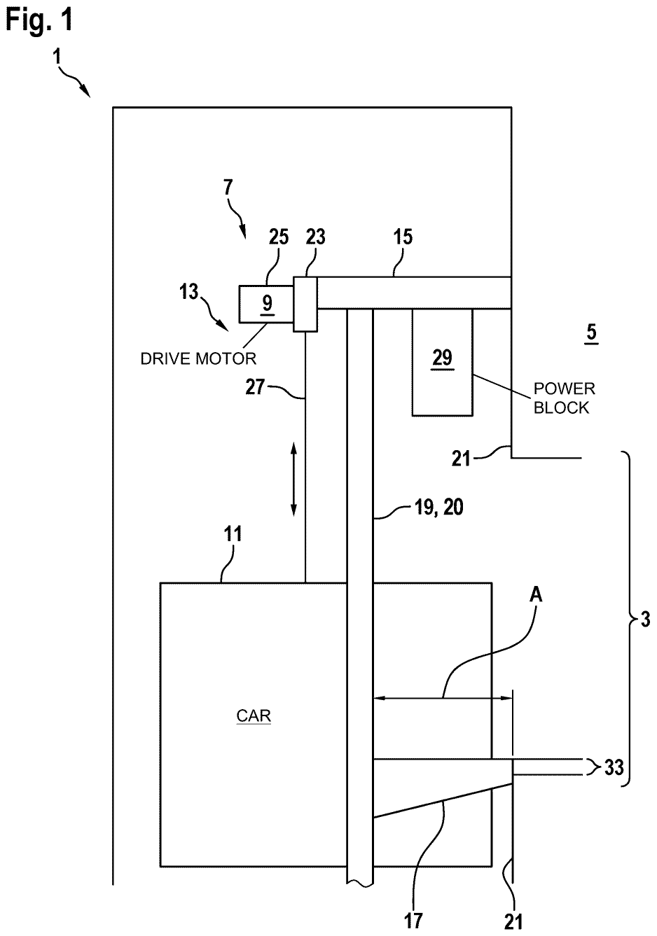

FIG. 1 shows an elevator system 1 which comprises a shaft 7 connecting a plurality of stories 3 of a building 5 to one another, and a car 11 that can be moved in the shaft 7 by means of a drive motor 9. In addition, the elevator system 1 comprises a device 13 for positioning the drive motor 9 in the shaft 7, here in a shaft head.

The device 13 comprises a carrier 15, a bracket 17 and a support 20. In the assembled state of the device 13 shown in FIG. 1, the carrier 15 is fastened with one of its ends to a side wall 21 of the shaft 7, so that a portion of the carrier 15 projects from the side wall 21 into the shaft 7. In this projecting portion, which here has a horizontal longitudinal direction, the carrier 15 has a receptacle 23 for fastening the drive motor 9 to the carrier 15. As shown in FIG. 1, the receptacle 23 can be arranged at a free end of the portion of the carrier 15 which projects into the shaft 7.

The bracket 17 is fastened to the same side wall 21 as the carrier 15 and is located below the carrier 15. The bracket 17 can be located below and the carrier 15 above a door opening, through which the shaft 7 is accessible to persons from one of the stories 3.

The support 20 is connected, for example screwed and/or welded, on the one hand to the portion of the carrier 15 projecting into the shaft 7 and on the other hand to a portion of the bracket 17 which projects into the shaft 7 a horizontal distance A from the side wall 21. Thus, the carrier 15 is supported on the bracket 17 via the support 20.

The drive motor 9 is fastened to the carrier 15 via the receptacle 23. In this example, the drive motor 9 is carried exclusively by the device 13, i.e., held at a defined position in the shaft 7. The receptacle 23 can additionally be supported on the support 20 and/or the bracket 17.

The drive motor 9 can comprise a housing 25 and be fastened to the receptacle 23 via its housing 25. Additional drive components such as a gear and/or a drive pulley for displacing a support means 27 connected to the car 11 and/or a counterweight can be arranged in and/or on the housing 25.

What is known as a power block 29 can additionally be fastened on the portion of the carrier 15 which projects into the shaft 7, for example between the support 20 and the side wall 21. Such a power block 29 may, for example, comprise a battery, a brake chopper, an elevator controller, or a combination of at least two of these examples.

In this example, the support 20 is formed by a longitudinal portion of a guide rail 19, preferably in the form of a hollow rail, for guiding the car 11 in the longitudinal direction of the shaft 7. In this case, the carrier 15 can rest on the upper end of the guide rail 19, as shown here. The guide rail 19 can be designed to additionally support the bracket 17.

The bracket 17 can be anchored in a floor 33 of one of the stories 3, here the uppermost story 3. Alternatively or additionally, the bracket 17 can be anchored in a portion of the side wall 21 located outside the floor 33, for example adjacent to the floor 33.

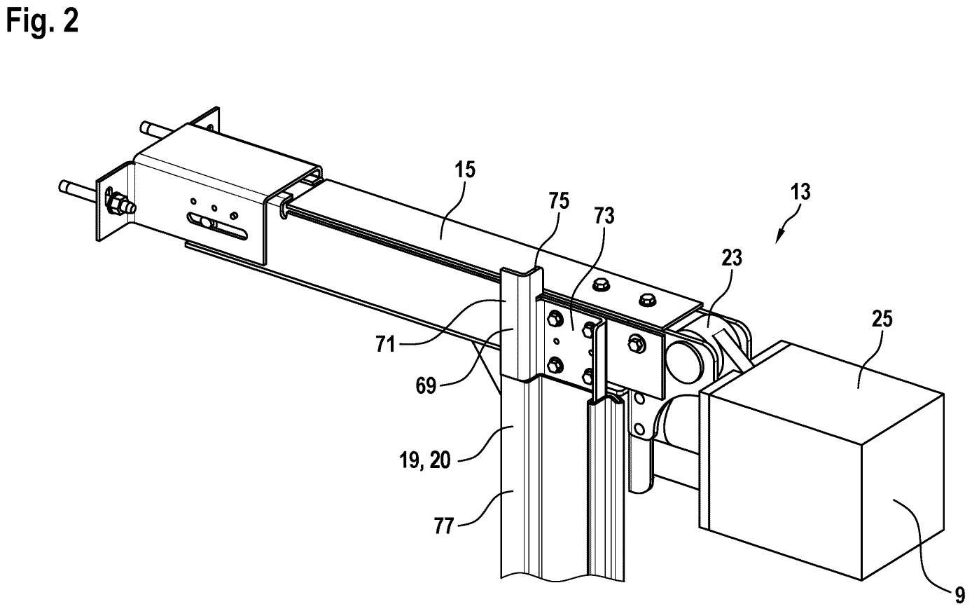

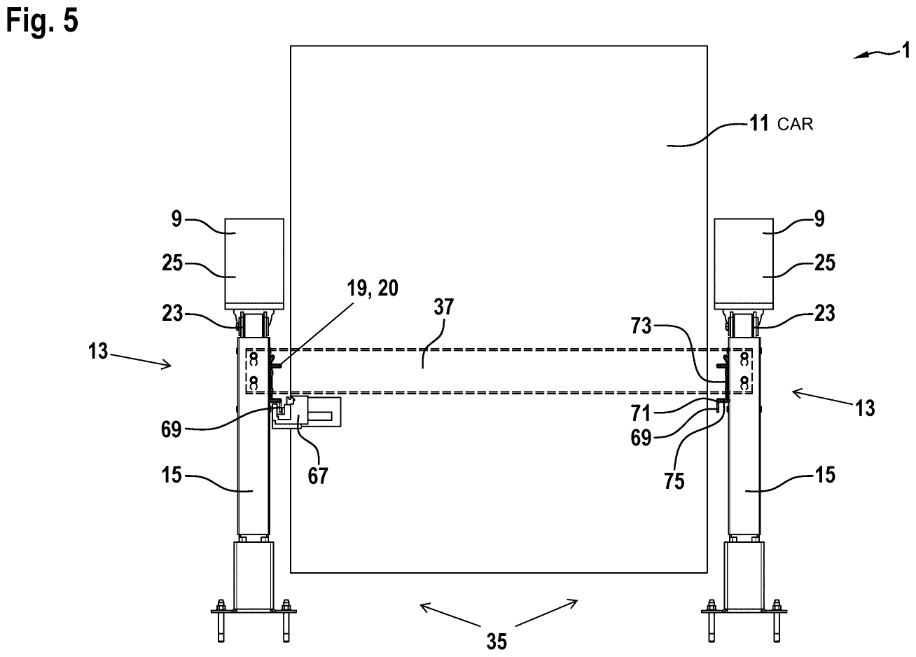

As can be seen in FIG. 2, a guide element 69 is attached to the carrier 15. This guide element 69 is arranged directly above the guide rail 19 and thus represents an extension of the guide rail 19. In the embodiment shown, the guide element 69 comprises a fastening portion 73, at which the guide element 69 is fixed to the carrier 15 by four screws, for example as shown in the embodiment, on a portion running parallel to the carrier 15. Furthermore, the guide element 69 has a guide portion with a guide surface 71, wherein the guide surface 71 is designed such that it runs parallel to a guide surface 77 of the guide rail 19. The guide surface 71 of the guide element 69 thus substantially represents a continuation of the guide surface 77 of the guide rail 19. A car brake 67 attached on the car 11 (see FIG. 5), which is guided on the guide rail 19 during travel in the shaft, can thus be guided by the guide element 69 when approaching the uppermost story in which the device 13 is attached during the last subportion of the travel (namely when the car brake is at the height of the carrier 15). The guide element 69 further has a connecting portion 75. In the embodiment shown, this connecting portion 75 runs perpendicularly to both the fastening portion 73 and the guide portion 71, and serves to connect these two portions. In the embodiment shown, the guide element 69 is designed as a sheet metal part formed in one piece.

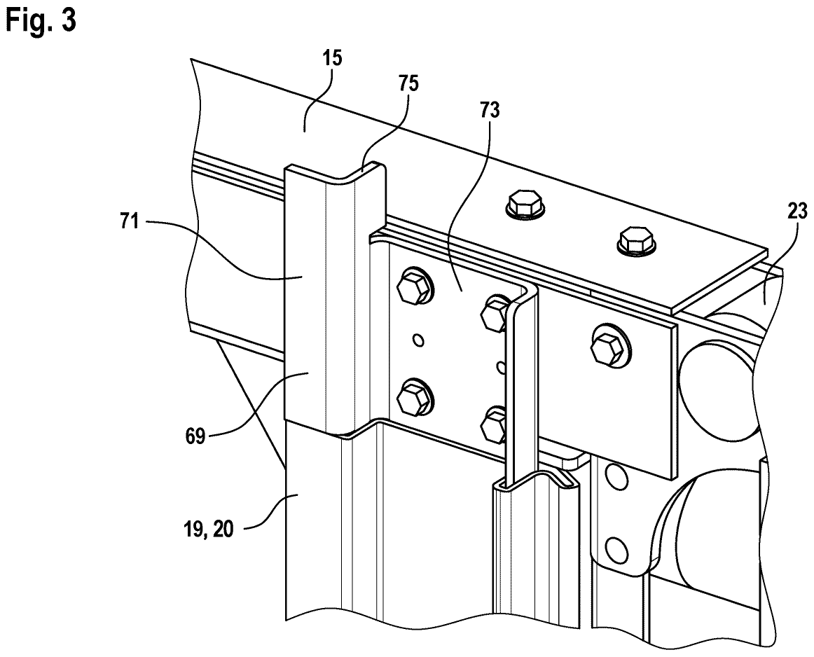

In FIG. 3, it can be seen that the fastening portion 73 is designed such that, in addition to the portion running parallel to the carrier (fastening surface 73), it also has a subportion running perpendicularly thereto, with which the fastening portion can be inserted or is inserted into the guide rail 19. By inserting the fastening portion into the guide rail 19, the guide element 69 can be or is fastened to the system (guide rail 19) with a positive fit. Furthermore, this subportion helps to place or align the fastening element 69 relative to the guide rail 19.

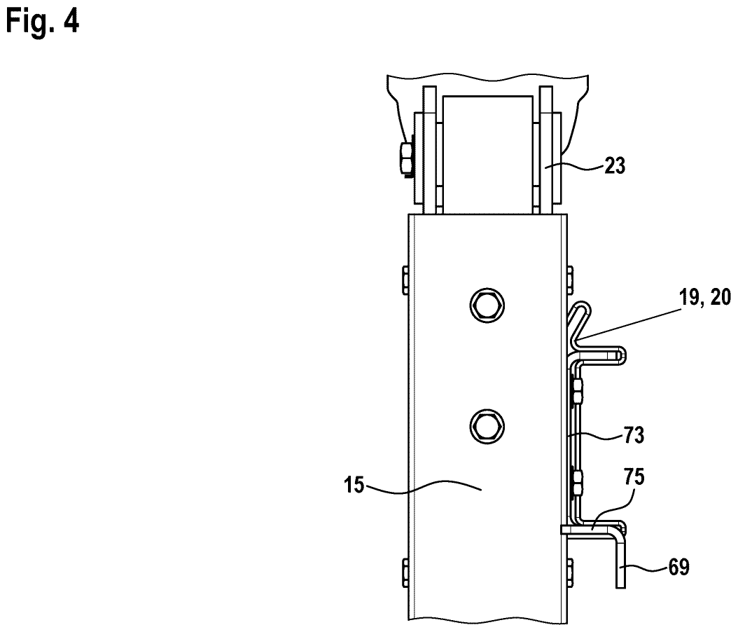

In FIG. 4, it can be seen how the fastening element 69 substantially represents an extension of the guide rail 19 along the carrier 15.

The elevator system 1 can also comprise two or more than two (preferably identical) examples of the device 13 described above, which then form a system 35 for carrying two or more than two drive motors 9 of the elevator system 1 (see FIG. 5). In this case, each of the drive motors 9 can be connected to one of the carriers 15 via one of the receptacles 23, i.e., each drive motor 9 can be carried by its own device 13.

As can be seen in FIG. 5, the carriers 15 of the system 35 can be connected to one another at their portions which project into the shaft 7 and via at least one connecting part 37 here in the form of a connecting plate, to form a particularly torsion-resistant frame.

The carriers 15 of different devices 13 can be arranged at the same height in the shaft 7 in the assembled state of the system 35. Additionally or alternatively, the brackets 17 of different devices 13 can be arranged at the same height in the shaft 7 when the system 35 is in the assembled state.

In the assembled state of the system 35, the car 11 can be arranged between the supports 20 or guide rails 19.

Finally, it should be noted that terms such as “having,” “comprising,” “including,” “with,” etc. do not exclude other elements or steps, and indefinite articles such as “a” or “an” do not exclude a plurality. Furthermore, it should be noted that features or steps that are described with reference to one of the above embodiments may also be used in combination with features or steps that are described with reference to other of the above embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. A device for carrying a drive motor of an elevator system, the elevator system having a shaft connecting a plurality of stories of a building to one another and a car moveable in the shaft between the stories, the car being moved by the drive motor and the car having a car brake attached to the car, the device comprising:
a carrier including a receptacle fastening the drive motor to one end of the carrier and an opposite end of the carrier being fastened in the shaft; and
a guide element attached to the carrier, the guide element guiding the car brake as the car moves in the shaft adjacent to the guide element.

16. The device according to claim 15 wherein the guide element is a sheet metal profile, the sheet metal profile having a guide portion with a guide surface guiding the car brake and a fastening portion at which the guide element is fastened to the carrier, the fastening portion having a fastening surface running parallel to the guide surface.

17. The device according to claim 15 wherein the guide element includes a connecting portion connecting the guide portion and the fastening portion, and wherein the connecting portion runs perpendicularly to the guide portion and/or the fastening portion.

18. The device according to claim 15 wherein the guide element a one-piece, bent sheet metal stamped part.

19. The device according to claim 15 including a bracket fastened in the shaft, wherein the elevator system includes a support connected to the bracket, the support being formed by a longitudinal portion of a guide rail extending in the shaft, the guide rail guiding the car during movement of the car in a longitudinal direction of the shaft.

20. The device according to claim 19 wherein the guide rail is a hollow rail with an end portion and/or wherein the longitudinal portion is the end portion of the guide rail and/or wherein the carrier rests on an upper end of the end portion of the guide rail, wherein the guide element has a fastening portion at which the guide element is fastened to the carrier, and wherein the fastening portion is form-fitted into the end portion of the guide rail.

21. The device according to claim 15 wherein the guide element has a guide portion with a guide surface guiding the car brake, wherein the elevator system includes a guide rail extending in the shaft and having a guide surface, the guide portion of the guide element being arranged adjacent to the guide rail such that the guide surface of the guide rail and the guide surface of the guide portion are arranged in plane with the guide surface of the guide element forming a continuation of the guide surface of the guide rail.

22. The device according to claim 15 wherein the opposite end of the carrier is fastened to a side wall and/or to ceiling of the shaft and the one end of the carrier with the receptacle projects into the shaft.

23. The device according to claim 15 wherein:
the guide element has a guide portion with a guide surface guiding the car brake and a fastening portion at which the guide element is fastened to the carrier, the fastening portion having a fastening surface running parallel to the guide surface;
the guide element includes a connecting portion connecting the guide portion and the fastening portion, the connecting portion running perpendicularly to the guide portion and/or the fastening portion;
the device includes a bracket fastened in the shaft, the elevator system including a support connected to the bracket, the support being formed by a longitudinal portion of a guide rail extending in the shaft, the guide rail guiding the car during movement of the car in a longitudinal direction of the shaft;
the guide rail is a hollow rail with an end portion and/or wherein the longitudinal portion is the end portion of the guide rail and/or wherein the carrier rests on an upper end of the end portion of the guide rail, wherein the guide element has a fastening portion at which the guide element is fastened to the carrier, and the fastening portion is form-fitted into the end portion of the guide rail;
the guide rail has a guide surface, the guide portion of the guide element being arranged adjacent to the guide rail such that the guide surface of the guide rail and the guide surface of the guide portion are arranged in plane with the guide surface of the guide element forming a continuation of the guide surface of the guide rail; and
the opposite end of the carrier is fastened to a side wall and/or to ceiling of the shaft and the one end of the carrier with the receptacle projects into the shaft.

24. A system for carrying a plurality of drive motors of an elevator system, the elevator system having a shaft connecting a plurality of stories of a building to one another and a car moveable in the shaft between the stories, the car being moved by the drive motors, the system comprising at least two of the devices according to claim 15, wherein the carrier of each of the device has the receptacle fastening one of the drive motors to the carrier.

25. The system according to claim 24 wherein the carriers of the at least two devices are fastened to a same side wall of the shaft.

26. The system according to claim 24 wherein the carriers of the at least two devices are connected to one another at portions that project into the shaft, the portions being connected by a connecting part to form a frame.

27. An elevator system comprising:
a shaft connecting a plurality of stories of a building to one another;
a car movable in the shaft between the stories;
a drive motor moving the car in the shaft; and
the device according to claim 15 having the drive motor fastened to the carrier via the receptacle.

28. An elevator system comprising:
a shaft connecting a plurality of stories of a building to one another;
a car movable in the shaft between the stories;
a first drive motor and a second drive motor moving the car in the shaft; and
two of the devices according to claim 15, a first of the devices having the first drive motor fastened to the carrier via the receptacle and a second of the devices having the second drive motor fastened to the carrier via the receptacle.

29. A method for assembling the device according to claim 15 in an elevator system, the elevator system including a shaft connecting a plurality of stories of a building to one another and a car moveable in the shaft between the stories by a drive motor, the method comprising steps of:
providing a support in the shaft;
fastening an end of the carrier of the device to a side wall and/or a ceiling of the shaft with the receptacle at an opposite end of the carrier projecting into the shaft;
fastening an end of the bracket of the device to the side wall, and/or the ceiling of the shaft, the bracket being arranged below the carrier; and
connecting the support to the carrier and to the bracket such that the support supports a portion of the carrier that projects into the shaft on a portion of the bracket that projects into the shaft.
